(19) United States
(12) Patent Application Publication
(10) Pub. No.: US 2015/0084909 A1
(43) Pub. Date: Mar. 26, 2015

(54) DEVICE AND METHOD FOR RESISTIVE FORCE SENSING AND PROXIMITY SENSING

(71) Applicant: SYNAPTICS INCORPORATED, San Jose, CA (US)

(72) Inventors: Patrick Worfolk, Campbell, CA (US); Pascale El Kallassi, Menlo Park, CA (US)

(21) Appl. No.: 14/033,151

(22) Filed: Sep. 20, 2013

(51) Int. Cl. G06F 3/045; G06F 3/041

(52) U.S. Cl. CPC G06F 3/045; G06F 3/0414
USPC 345/174

(57) ABSTRACT

Methods, systems and devices are described for operating input device for an electronic system including a pliable component having an input surface and a first plurality of sensor electrodes configured to sense input objects in a sensing region of the input device. The input device also includes a support substrate including at least one second sensor electrode spaced apart from the pliable component, and a patterned force sensitive resistance (FSR) layer disposed between the first plurality of sensor electrodes and the at least one second sensor electrode.

### TECHNICAL FIELD

This invention generally relates to electronic devices, and more specifically relates to sensor devices and using sensor devices for producing user interface inputs.

### BACKGROUND

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

The proximity sensor device can be used to enable control of an associated electronic system. For example, proximity sensor devices are often used as input devices for larger computing systems, including: notebook computers and desktop computers. Proximity sensor devices are also often used in smaller systems, including: handheld systems such as personal digital assistants (PDAs), remote controls, and communication systems such as wireless telephones and text messaging systems. Increasingly, proximity sensor devices are used in media systems, such as CD, DVD, MP3, video or other media recorders or players. The proximity sensor device can be integral or peripheral to the computing system with which it interacts.

Some input devices also have the ability to detect applied force in addition to determining positional information for input objects interacting with a sensing region of the input device. However, in presently known force/touch input devices, the force is sensed capacitively. An improved force enabled image sensor is needed which overcomes the limitations of presently known capacitive force sensing input devices.

### BRIEF SUMMARY

Embodiments of the present invention provide a device and method that facilitates improved device usability. The device and method provide improved user interface functionality through the use of a resistive force sensing regime employing a force sensitive resistance (FSR) material. By strategically arranging the FSR material, the touch sensor electrodes and force sensor electrodes, and optional spacer dots which may be conductive or non-conductive and rigid or compressible, efficiencies may be obtained in terms of manufacturing cost, device size, and device performance.

### BRIEF DESCRIPTION OF DRAWINGS

The preferred exemplary embodiment of the present invention will hereinafter be described in conjunction with the appended drawings, where like designations denote like elements, and:

FIG. 1 is a block diagram of an exemplary electronic system that includes an input device and a processing system in accordance with an embodiment;

FIG. 2 is a schematic view of an exemplary processing system in accordance with an embodiment;

FIG. 3 is a schematic cross-section view of a conceptual layout for a touch and force sensor, where both the force sensor and touch sensor include separate transmitter and receiver electrode layers in accordance with an embodiment;

FIG. 4 is schematic cross section view of a conceptual layout for a touch and force sensor, where the touch and force sensor share a common layer of transmitter electrodes in accordance with an embodiment;

FIG. 5 is a schematic cross section view of a preferred embodiment of an input device stack-up including a common layer of transmitter electrodes shared by the touch sensor and the force sensor, a force sensitive resistance (FSR) layer, and optional spacer dots in accordance with an embodiment;

FIG. 6 is a schematic cross section view of an input device stack-up employing double sided touch and force sensors, an FSR layer, and an optional spacer dot layer in accordance with an embodiment;

FIG. 7 is a schematic cross section view of an input device stack-up similar to FIG. 6, but employing single sided touch and force sensors, in accordance with an embodiment;

FIG. 8 is a schematic cross section view of an input device stack-up depicting compound single sided sensors with a shared substrate in accordance with an embodiment;

FIG. 9 is a schematic cross section view of an input device stack-up depicting compound single sided sensors with shared transmitter electrodes in accordance with an embodiment; and

FIG. 10 is a schematic cross section view of an input device stack-up depicting conductive compressible dots aligned with corresponding force receiver electrodes and an optional FSR layer in accordance with an embodiment.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Various embodiments of the present invention provide input devices and methods that facilitate improved usability. User interface functionality may be enhanced by employing resistive force sensors embodying force sensitive resistive (FSR) or piezo-resistive materials, of which there are two general varieties: surface effect and bulk effect. Both exhibit decreased resistance (higher conductivity) with increasing applied force.

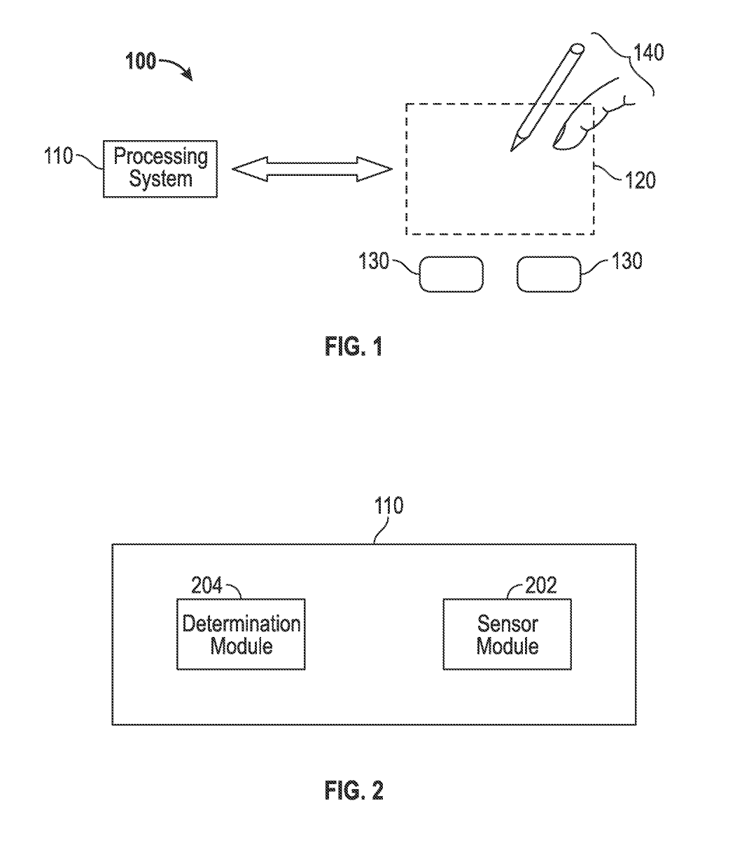

Turning now to the figures, FIG. 1 is a block diagram of an exemplary input device 100 in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In a preferred embodiment, the input device 100 is implemented as a force enabled touchpad system including a processing system 110 and a sensing region 120. Sensing region 120 (also often referred to as “touchpad”) is configured to sense input provided by one or more input objects 140 in the sensing region 120. Example input objects include fingers, thumb, palm, and styli. The sensing region 120 is illustrated schematically as a rectangle; however, it should be understood that the sensing region may be of any convenient form and in any desired arrangement on the surface of and/or otherwise integrated with the touchpad.

Sensing region 120 includes sensors for detecting force and proximity, as described in greater detail below in conjunction with FIG. 2. Sensing region 120 may encompass any space above (e.g., hovering), around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device is adapted to provide user interface functionality by facilitating data entry responsive to the position of sensed objects and the force applied by such objects. Specifically, the processing system is configured to determine positional information for objects sensed by a sensor in the sensing region. This positional information can then be used by the system to provide a wide range of user interface functionality. Furthermore, the processing system is configured to determine force information for objects from measures of force determined by the sensor in the sensing region. This force information can then also be used by the system to provide a wide range of user interface functionality, for example, by providing different user interface functions in response to different levels of applied force by objects in the sensing region. Furthermore, the processing system may be configured to determine input information for more than one object sensed in the sensing region. Input information can be based upon a combination the force information, the positional information, the number of input objects in the sensing region and/or in contact with the input surface, and a duration the one or more input objects is touching or in proximity to the input surface. Input information can then be used by the system to provide a wide range of user interface functionality.

The input device is sensitive to input by one or more input objects (e.g. fingers, styli, etc.), such as the position of an input object within the sensing region. The sensing region encompasses any space above, around, in and/or near the input device in which the input device is able to detect user input (e.g., user input provided by one or more input objects). The sizes, shapes, and locations of particular sensing regions may vary widely from embodiment to embodiment. In some embodiments, the sensing region extends from a surface of the input device in one or more directions into space until signal-to-noise ratios prevent sufficiently accurate object detection. The distance to which this sensing region extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device, contact with an input surface (e.g. a touch surface) of the input device, contact with an input surface of the input device coupled with some amount of applied force, and/or a combination thereof. In various embodiments, input surfaces may be provided by surfaces of casings within which the sensor electrodes reside, by face sheets applied over the sensor electrodes or any casings.

The electronic system 100 may utilize any combination of sensor components and sensing technologies to detect user input (e.g., force, proximity) in the sensing region 120 or otherwise associated with the touchpad. The input device 102 comprises one or more sensing elements for detecting user input. As several non-limiting examples, the input device 100 may use capacitive, elastive, resistive, inductive, magnetic, acoustic, ultrasonic, and/or optical techniques.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements pick up loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self-capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

It should also be understood that the input device may be implemented with a variety of different methods to determine force imparted onto the input surface of the input device. For example, the input device may include mechanisms disposed proximate the input surface and configured to provide an electrical signal representative of an absolute or a change in force applied onto the input surface. In some embodiments, the input device may be configured to determine force information based on a defection of the input surface relative to a conductor (e.g. a display screen underlying the input surface). In some embodiments, the input surface may be configured to deflect about one or multiple axis. In some embodiments, the input surface may be configured to deflect in a substantially uniform or non-uniform manner.

In FIG. 1, a processing system 110 is shown as part of the input device 100. However, in other embodiments the processing system may be located in the host electronic device with which the touchpad operates. The processing system 110 is configured to operate the hardware of the input device 100 to detect various inputs from the sensing region 120. The processing system 110 comprises parts of or all of one or more integrated circuits (ICs) and/or other circuitry components. For example, a processing system for a mutual capacitance sensor device may comprise transmitter circuitry configured to transmit signals with transmitter sensor electrodes, and/or receiver circuitry configured to receive signals with receiver sensor electrodes). In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as graphical user interface (GUI) actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions. The types of actions may include, but are not limited to, pointing, tapping, selecting, clicking, double clicking, panning, zooming, and scrolling. Other examples of possible actions include an initiation and/or rate or speed of an action, such as a click, scroll, zoom, or pan.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information, particularly regarding the presence of an input object in the sensing region. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

Likewise, the term “force information” as used herein is intended to broadly encompass force information regardless of format. For example, the force information can be provided for each input object as a vector or scalar quantity. As another example, the force information can be provided as an indication that determined force has or has not crossed a threshold amount. As other examples, the force information can also include time history components used for gesture recognition. As will be described in greater detail below, positional information and force information from the processing systems may be used to facilitate a full range of interface inputs, including use of the proximity sensor device as a pointing device for selection, cursor control, scrolling, and other functions.

Likewise, the term “input information” as used herein is intended to broadly encompass temporal, positional and force information regardless of format, for any number of input objects. In some embodiments, input information may be determined for individual input objects. In other embodiments, input information comprises the number of input objects interacting with the input device.

In some embodiments, the input device 100 is implemented with additional input components that are operated by the processing system 110 or by some other processing system. These additional input components may provide redundant functionality for input in the sensing region 120, or some other functionality. For example, buttons (not shown) may be placed near the sensing region 120 and used to facilitate selection of items using the input device 102. Other types of additional input components include sliders, balls, wheels, switches, and the like. Conversely, in some embodiments, the input device 100 may be implemented with no other input components.

In some embodiments, the electronic system 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

It should also be understood that the input device may be implemented with a variety of different methods to determine force imparted onto the input surface of the input device. For example, the input device may include mechanisms disposed proximate the input surface and configured to provide an electrical signal representative of an absolute or a change in force applied onto the input surface. In some embodiments, the input device may be configured to determine force information based on a defection of the input surface relative to a conductor (e.g. a display screen underlying the input surface). In some embodiments, the input surface may be configured to deflect about one or multiple axis. In some embodiments, the input surface may be configured to deflect in a substantially uniform or non-uniform manner.

As described above, in some embodiments some part of the electronic system processes information received from the processing system to determine input information and to act on user input, such as to facilitate a full range of actions. It should be appreciated that some uniquely input information may result in the same or different action. For example, in some embodiments, input information for an input object comprising, a force value F, a location X,Y and a time of contact T may result in a first action. While input information for an input object comprising a force value F′, a location X′,Y′ and a time of contact T′ (where the prime values are uniquely different from the non-prime values) may also result in the first action. Furthermore, input information for an input object comprising a force value F, a location X′,Y and a time of contact T′ may result in a first action. While the examples below describe actions which may be performed based on input information comprising a specific range of values for force, position and the like, it should be appreciated that that different input information (as described above) may result in the same action. Furthermore, the same type of user input may provide different functionality based on a component of the input information. For example, different values of F, X/Y and T may result in the same type of action (e.g. panning, zooming, etc.), that type of action may behave differently based upon said values or other values (e.g. zooming faster, panning slower, and the like).

As noted above, the embodiments of the invention can be implemented with a variety of different types and arrangements of capacitive sensor electrodes for detecting force and/or positional information. To name several examples, the input device can be implemented with electrode arrays that are formed on multiple substrate layers, typically with the electrodes for sensing in one direction (e.g., the “X” direction) formed on a first layer, while the electrodes for sensing in a second direction (e.g., the “Y” direction are formed on a second layer. In other embodiments, the sensor electrodes for both the X and Y sensing can be formed on the same layer. In yet other embodiments, the sensor electrodes can be arranged for sensing in only one direction, e.g., in either the X or the Y direction. In still another embodiment, the sensor electrodes can be arranged to provide positional information in polar coordinates, such as “τ” and “θ” as one example. In these embodiments the sensor electrodes themselves are commonly arranged in a circle or other looped shape to provide “θ”, with the shapes of individual sensor electrodes used to provide “r”.

Also, a variety of different sensor electrode shapes can be used, including electrodes shaped as thin lines, rectangles, diamonds, wedge, etc. Finally, a variety of conductive materials and fabrication techniques can be used to form the sensor electrodes. As one example, the sensor electrodes are formed by the deposition and etching of conductive ink on a substrate.

In some embodiments, the input device is comprises a sensor device configured to detect contact area and location of a user interacting with the device. The input sensor device may be further configured to detect positional information about the user, such as the position and movement of the hand and any fingers relative to an input surface (or sensing region) of the sensor device.

In some embodiments, the input device is used as an indirect interaction device. An indirect interaction device may control GUI actions on a display which is separate from the input device, for example a touchpad of a laptop computer. In one embodiment, the input device may operate as a direct interaction device. A direct interaction device controls GUI actions on a display which underlies a proximity sensor, for example a touch screen. There are various usability differences between indirect and direct more which may confuse or prevent full operation of the input device. For example, an indirect input device may be used to position a cursor over a button by moving an input object over a proximity sensor. This is done indirectly, as the motion of the input does not overlap the response on the display. In a similar case, a direct interaction device may be used to position a cursor over a button by placing an input object directly over or onto the desired button on a touch screen.

Referring now to FIGS. 1 and 2, the processing system 110 includes a sensor module 202 and a determination module 204. Sensor module 202 is configured to receive resulting signals from the sensors associated with sensing region 120. Determination module 204 is configured to process the data, and to determine positional information and force information. The embodiments of the invention can be used to enable a variety of different capabilities on the host device. Specifically, it can be used to enable cursor positioning, scrolling, dragging, icon selection, closing windows on a desktop, putting a computer into sleep mode, or perform any other type of mode switch or interface action.

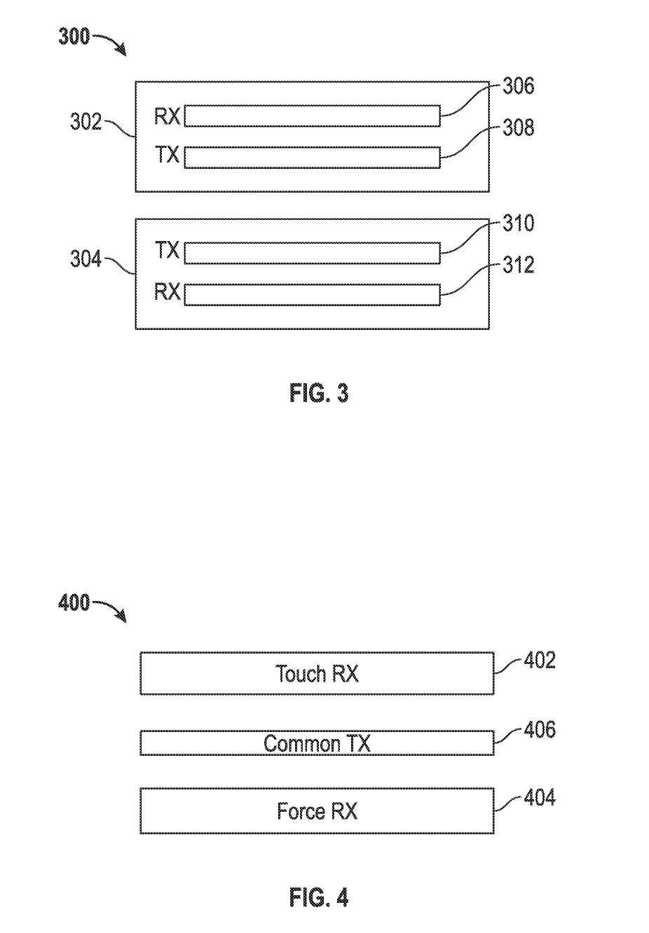

FIG. 3 is a conceptual layout for a touch and force sensor stack-up 300, where both the force sensor assembly and touch sensor assembly include separate transmitter and receiver electrode layers. More particularly, stack-up 300 includes a touch sensor substrate 302 and a force sensor substrate 304. The touch sensor substrate 302 includes a touch receiver electrode layer 306 and a touch transmitter electrode layer 308. The force sensor substrate 304 includes a force transmitter electrode layer 310 and a force receiver electrode layer 312. As explained in greater detail below in conjunction with FIGS. 4-9, various manufacturing and performance efficiencies and advantages may be realized by sharing and strategically arranging one or more of the electrode layers and substrate layers.

For example, FIG. 4 is conceptual layout for a touch and force sensitive input device 400, where the touch and force sensor share a common layer of transmitter electrodes. More particularly, the input device 400 includes a touch receiver electrode layer 402, a force receiver electrode layer 404, and a transmitter electrode layer 406 which is shared between the touch sensor and the force sensor. That is, the respective transmitters comprising transmitter electrode layer 406 may be alternately driven to produce: i) a resulting proximity signal at the touch receiver electrode layer 402; and ii) a resulting force signal at the force receiver electrode layer 404. In alternate embodiments, the transmitters comprising transmitter electrode layer 406 may be simultaneously driven to produce a resulting proximity signal at the touch receiver electrode layer 402 and a resulting force signal at the force receiver electrode layer 404

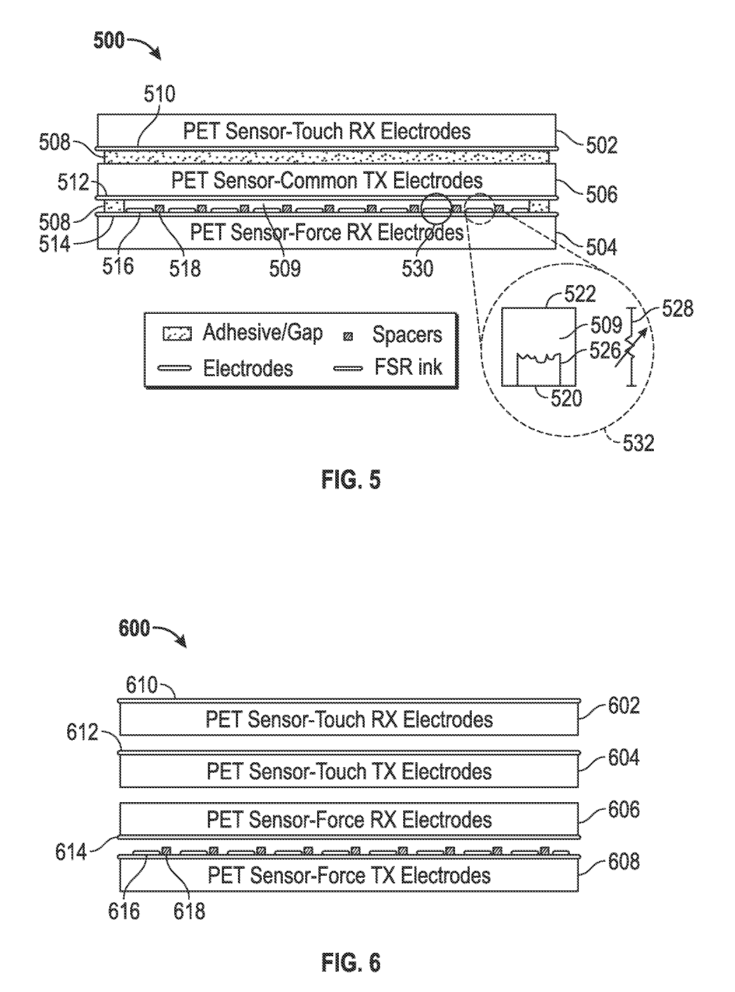

FIG. 5 is a schematic cross section view of a preferred embodiment of an input device stack-up 500 including a common layer of transmitter electrodes shared by the touch sensor and the force sensor. More particularly, the input device stack-up 500 includes a touch receiver substrate 502 having a touch receiver electrode layer 510, a force receiver substrate 504 having a force receiver electrode layer 514, a common (touch and force) transmitter substrate 506 having a transmitter electrode layer 512, a patterned force sensitive resistance (FSR) layer 516 (e.g., FSR ink), and an optional array of spacer dots 518 interposed between respective FSR resistors. One or more of the substrate layers may be in the form of polyethylene terephthalate (PET) film. An adhesive layer 508 and/or air gap 509 is suitably disposed between adjacent substrate layers. Those skilled in the art will appreciate that the spacer dots 518 may be in the form of dots, hemi-spheres or partial spheres, or any other regular, irregular, patterned or random group of geometric shapes disposed proximate force electrode layer 514 which effectively separate various components (e.g., patterned FSR components) from one another.

Those skilled in the art will also appreciate that the transmitter electrode layer 512 and the touch receiver electrode layer 510 cooperate to form a capacitive proximity sensor for detecting input objects in the sensing region associated with the input device stack-up 500. The transmitter electrode layer 512 and the force receiver electrode layer 514, in conjunction with the FSR layer 516, cooperate to form a resistive force sensor for determining force applied by input objects.

More particularly, the transmitter electrode layer 512 and the force receiver electrode layer 514 are configured to form a plurality (e.g., an array) of force pixels (or “fixels”) 530. The force sensing mechanism of a fixel 530 is schematically illustrated in an exploded view 532, which depicts a force transmitter electrode 522, a force receiver electrode 520, and an FSR material 526 in an air gap 509 between the electrodes. In response to applied force, the fixel 530 is compressed thereby changing (e.g., decreasing) the resistance of the fixel system (which may be modeled to a first degree of approximation as a variable resistor 528).

FIG. 6 illustrates an alternate embodiment of an input device stack-up 600 employing double sided touch and force sensors. More particularly, stack-up 600 includes a touch receiver substrate 602 having a touch receiver electrode layer 610, a touch receiver substrate 604 having a touch transmitter electrode layer 612, a force receiver substrate 606 having a force receiver electrode layer 614, a force transmitter substrate 608 having a force transmitter electrode layer 616, a patterned force sensitive resistance (FSR) layer 616, and an optional array of spacer dots 618, for example, interposed between respective FSR resistors.

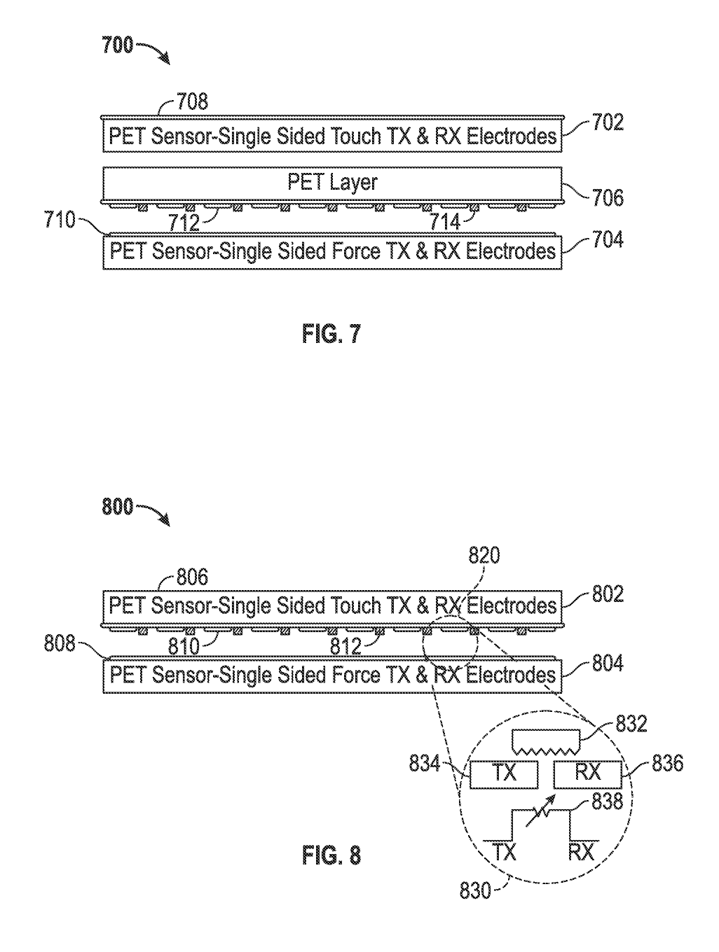

FIG. 7 is a schematic cross section view of an input device stack-up 700 similar to the stack-ups in FIGS. 5 and 6, but employing single sided touch and force sensors. That is, stack-up 700 includes a touch sensor substrate 702 having a combined touch transmitter and touch receiver electrode layer 708 disposed on a single side of the substrate 702, an intermediate substrate 706 supporting a patterned force sensitive resistance (FSR) layer 712 and an optional array of spacer dots 714 interposed between respective FSR resistors, and a force sensor substrate 704 having a combined force transmitter and force receiver electrode layer 710 disposed on a single side thereof

FIG. 8 is a schematic cross section view of an input device stack-up 800 depicting compound single sided sensors. More particularly, stack-up 800 includes a touch sensor substrate 802 having a combined touch transmitter and touch receiver electrode layer 806 disposed on a single side of the substrate 802, and a force sensor substrate 804 having a combined force transmitter and force receiver electrode layer 808 disposed on a single side thereof. The touch sensor substrate 802 also supports a patterned force sensitive resistance (FSR) layer 810 and an optional array of spacer dots 812 interposed between respective FSR resistors.

With continued reference to FIG. 8, the force transmitter and force receiver electrode layer 808 is configured to form a plurality (e.g., an array) of force pixels (or “fixels”) 820. The force sensing mechanism of a fixel 820 is schematically illustrated in an exploded view 830, which depicts a force transmitter electrode 834 and a force receiver electrode 836 (both being part of force receiver electrode layer 808 in the illustrated embodiment), and an FSR-type resistor 832 disposed above and spanning the electrodes. In response to applied force, the FSR resistor contacts transmitter electrode 834 and receiver electrode 836 and is compressed, thereby changing (e.g., decreasing) the resistance of the fixel which may be modeled as a variable resistor 838.

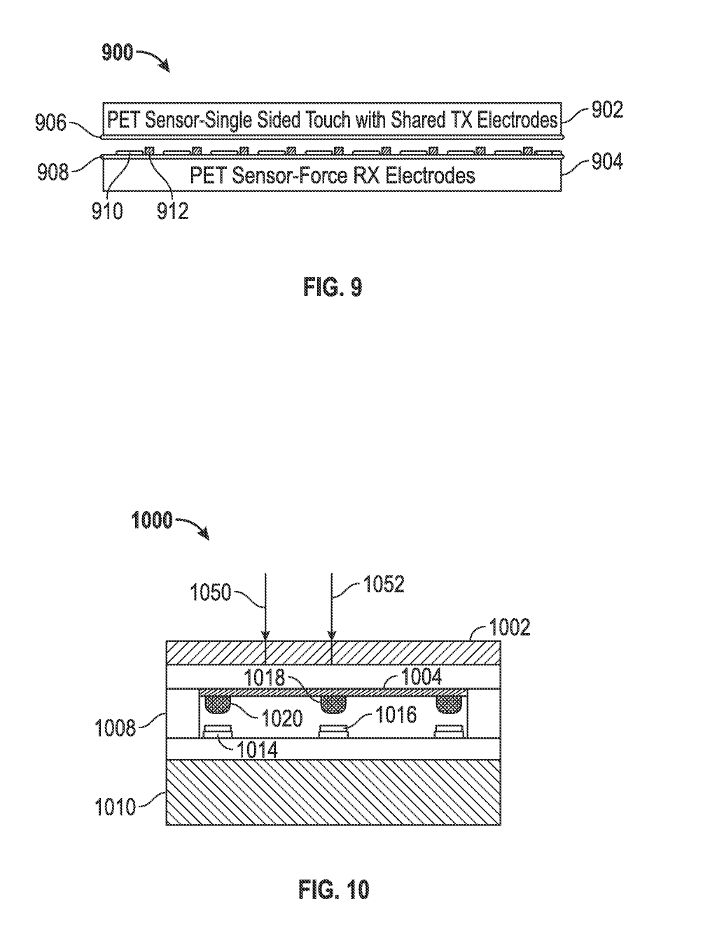

In a particularly preferred embodiment, FIG. 9 illustrates an input device stack-up 900 depicting compound single sided sensors with shared transmitter electrodes. More particularly, the input device stack-up 900 includes a touch sensor substrate 902 having a combined touch transmitter and touch receiver electrode layer 906 disposed on a single side of the substrate 902, and a force sensor substrate 904 having a force receiver electrode layer 908, where the transmitter electrodes in layer 906 are shared between the touch sensor and the force sensor. That is, the transmitter electrodes are configured to capacitively couple with the touch receiver electrode layer and to resistively couple with the force receiver electrode layer. The force sensor substrate 904 also supports a patterned force sensitive resistance (FSR) layer 910 and an optional array of spacer dots 912 interposed between respective FSR resistors on the top side of the force sensor substrate 904. Alternatively, the FSR layer and the spacer dots may be disposed on substrate 902.

In another embodiment, similar to FIG. 9, an input device 900 may include a single sided sensor with shared transmitter and receiver electrodes. More particularly, the input device 900 includes a touch sensor substrate 902 having a combined touch and force transmitter and receiver electrodes 906. In such an embodiment, the transmitter and receiver electrodes 906 are shared between the touch sensor and the force sensor. In such an embodiment, force receiver electrodes 908, as illustrated in FIG. 9, may be omitted. A support substrate 904 supports a patterned force sensitive resistance (FSR) layer 910 and an optional array of space dots 912 interposed between respective FSR resistors. Alternatively, the FSR layer and the spacer dots may be disposed on substrate 902. In such an embodiment, sensor electrodes 902 may be used to measure input object proximity (e.g. via capacitive sensing) and force applied to the input surface (e.g. via resistive sensing using only sensor electrodes 902).

In a capacitive sensing regime, any suitable sensing circuit which includes a current (or charge) integrator may be employed to determine proximity (touch) and/or force information for input objects interacting with the aforementioned pixels and fixels in the sensing region.

In the embodiments described above in connection with FIGS. 5-9, it is possible to obtain a muted force signal (or none at all) if the input object applies pressure directly over a rigid spacer dot, and the input object is either flat (not deformable) or very thin, such as a stylus. That is, under certain circumstances, applied pressure may not result in compression of an FSR resistor depending on the arrangement of the rigid spacer dots relative to the point of applied pressure. To mitigate this circumstance, an alternate embodiment contemplates aligning conductive spacer dots either directly over an FSR resistor.

Referring now to FIG. 10, a schematic cross section view of an input device stack-up 1000 is shown with conductive compressible dots aligned with corresponding force receiver electrodes using an FSR layer. More particularly, input device stack-up 1000 includes a pliable component 1002 having touch sensor electrodes (not shown), an intermediate layer 1003 (which may be pliable layer 1002) supporting a force transmitter electrode layer 1004 and an array of conductive spacer dots 1018 which may be rigid or compressible, and a substrate layer 1010 supporting a force receiver electrode layer 1014. A gasket layer 1008 (e.g., adhesive) may be used to maintain an initial separation between the force transmitter and force receiver electrode layers, if desired. In addition, a patterned FSR layer 1016 of FSR material is disposed in alignment with the spacer dots.

With continued reference to FIG. 10, when an applied force along arrow 1052 is aligned with one of the conductive spacer dots 1018, a force signal may be determined based on the change in resistance of at least the FSR resistor incorporating FSR material 1016 along the line defined by arrow 1052 as discussed above. Alternatively, when force is applied along an arrow 1050 between two conductive dots 1018 and 1020, a force signal may be determined based on the change in resistance of two or more FSR resistors (e.g., FSR resistors 1014 and 1016) as they press against corresponding spacer dots 1020 and 1018, respectively.

An input device for use with an electronic system is thus provided which includes a pliable component having an input surface and a first plurality of sensor electrodes configured to sense input objects in a sensing region of the input device. The input device further includes a support substrate including at least one second sensor electrode spaced apart from the pliable component, and a patterned force sensitive resistance (FSR) layer disposed between the first plurality of sensor electrodes and the at least one second sensor electrode.

In an embodiment, the FSR layer comprises at least one of a surface effect material and a bulk effect material, and wherein in response to force applied to the pliable component, the electrical resistance between the first plurality of sensor electrodes and the at least one second sensor electrode changes based on at least one of: i) increased surface area of the FSR layer coming into contact with one or both of the first plurality of sensor electrodes and the at least one second sensor electrode; and ii) a change in the bulk resistance of the FSR layer.

In another embodiment, the at least one second sensor electrode comprises a second plurality of force sensitive sensor electrodes configured to measure a force applied to the input surface, and the FSR layer comprises a non-overlapping pattern of conductive spacers interposed between respective ones of the force sensitive electrodes. Alternatively, the FSR layer comprises a pattern of FSR material overlapping the force sensitive electrodes.

In a further embodiment, the input device includes an array of conductive material disposed between the first plurality of sensor electrodes and the at least one second sensor electrode, the array of conductive material configured to overlap the patterned FSR layer.

In another embodiment, the conductive material is substantially compressible, and/or the conductive material is in ohmic contact with the FSR layer.

In a further embodiment, the conductive material is spaced apart from the FSR layer. Alternatively, the conductive material may be disposed onto the pliable component and/or the FSR layer.

In another embodiment, the conductive material is configured to mechanically contact the pliable component and the support substrate.

In a further embodiment, a spacing layer may be provided to overlap the FSR layer.

In another embodiment, the at least one second sensor electrode may be configured to measure a deflection of the pliable component towards the support substrate in response to input object pressure on the input surface.

In an embodiment, the measurement of the deflection may be based on a measurement of the change in resistance between a subset of the first array and the at least one second sensor electrode.

In another embodiment, the measurement of the deflection may be based on a change in the total resistivity of the FSR layer.

In a further embodiment, the input device may also include a processing system communicatively coupled to and configured to operate the first plurality of sensor electrodes and the at least one second sensor electrode. The processing system may be configured to perform trans-capacitive sensing using the first plurality of sensor electrodes to determine positional information for input objects in the sensing region, and perform resistive sensing between a subset of the first plurality of sensor electrodes and the at least one second sensor to determine applied pressure to the input surface based on a change in resistance of the FSR layer.

The processing system may also be configured to: drive a sensing signal on a first subset of the first plurality of sensor electrodes, and receive a first resulting signal from the at least one second sensor electrode to determine positional information for the input objects; and receive a second resulting signal from the at least one second sensor electrode to determine force information for the input objects; wherein the first and second resulting signals correspond to the same driven signal.

An input device is also provided which includes a pliable component having a first plurality of sensor electrodes configured to detect input objects in a sensing region of the input device, the first plurality of sensor electrodes including a first subset of transmitter electrodes. The input device may also include a second plurality of sensor electrodes configured to detect a force imparted to an input surface of the input device and configured for resistive coupling with the first subset of transmitter electrodes, and a patterned force sensitive resistance (FSR) layer disposed between the pliable component and the second plurality of sensor electrodes; wherein the resistive coupling between the transmitter electrodes and the second plurality of sensor electrodes varies in response to the applied force.

In an embodiment, the input device further includes a processing system communicatively coupled to and configured to operate the first and second pluralities of sensor electrodes. The processing system may be configured to perform trans-capacitive sensing using the first plurality of sensor electrodes to determine positional information for input objects in the sensing region, and to perform resistive sensing between a subset of the first plurality of sensor electrodes and the second plurality of sensor electrodes to determine applied pressure to the input surface based on a deflection of the first plurality of sensor electrodes relative to the second plurality of sensor electrodes.

An input device is also provided which includes a first plurality of sensor electrodes disposed in a pliable component and configured to detect input objects in a sensing region of the input device; a second plurality of sensor electrodes disposed in a second layer and configured to detect a force imparted to an input surface of the input device; a patterned force sensitive resistance (FSR) layer disposed between the pliable component and the second plurality of sensor electrodes and configured to change total resistivity in response to force applied to the input surface such that a resistive coupling between the first and second pluralities of sensor electrodes varies in response to the applied force; and a processing system communicatively coupled to the first and second pluralities of sensor electrodes.

In an embodiment, the processing system may be configured to: drive a sensing signal onto a first subset of the first plurality of sensor electrodes; receive a first resulting signal, including effects of an input object in the sensing region, from a second subset of the first plurality of sensor electrodes; receive a second resulting signal, including effects of a force imparted on the input surface, from the second plurality of sensor electrodes; and determine positional and force information for input objects in the sensing region based on the first and second resulting signals.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Other embodiments, uses, and advantages of the invention will be apparent to those skilled in art from the specification and the practice of the disclosed invention.

What is claimed is:

1. An input device for an electronic system, comprising:
a pliable component having:
an input surface;
a first plurality of sensor electrodes configured to sense input objects in a sensing region of the input device;
a support substrate including at least one second sensor electrode spaced apart from the pliable component; and
a patterned force sensitive resistance (FSR) layer disposed between the first plurality of sensor electrodes and the at least one second sensor electrode.

2. The input device of claim 1, wherein the FSR layer comprises at least one of a surface effect material and a bulk effect material, and wherein in response to force applied to the pliable component, the electrical resistance between the first plurality of sensor electrodes and the at least one second sensor electrode changes based on at least one of: i) increased surface area of the FSR layer coming into contact with one or both of the first plurality of sensor electrodes and the at least one second sensor electrode; and ii) a change in bulk resistance of the FSR layer.

3. The input device of claim 1, wherein the at least one second sensor electrode is configured to measure a force applied to the input surface, and the FSR layer comprises a non-overlapping pattern of spacer material interposed between respective ones of the force sensitive electrodes.

4. The input device of claim 1, wherein the at least one second sensor electrode is configured to measure a force applied to the input surface, and the FSR layer comprises a pattern of FSR material overlapping the force sensitive electrodes.

5. The input device of claim 1, further comprising an array of conductive material disposed between the first plurality of sensor electrodes and the at least one second sensor electrode, the array of conductive material configured to overlap the patterned FSR layer.

6. The input device of claim 5, wherein the conductive material is substantially compressible.

7. The input device of claim 5, wherein the conductive material is in ohmic contact with the FSR layer.

8. The input device of claim 5, wherein the conductive material is spaced apart from the FSR layer.

9. The input device of claim 5, wherein the conductive material is disposed onto one of: the pliable component and the FSR layer.

10. The input device of claim 5, wherein the conductive material mechanically contacts the pliable component and the support substrate.

11. The input device of claim 1, wherein the at least one second sensor electrode is configured to measure a deflection of the pliable component towards the support substrate in response to input object pressure onto the input surface.

12. The input device of claim 11, wherein the measurement of the deflection is based on a measurement of the change in resistance between a subset of the first array and the at least one second sensor electrode.

13. The input device of claim 11, wherein the measurement of the deflection is based on a change in the total resistivity between the at least one second sensor electrode and a force receiver electrode.

14. The input device of claim 1, further comprising a processing system communicatively coupled to and configured to operate the first plurality of sensor electrodes and the at least one second sensor electrode, the processing system configured to:
perform trans-capacitive sensing using the first plurality of sensor electrodes to determine positional information for input objects in the sensing region; and
perform resistive sensing between a subset of the first plurality of sensor electrodes and the at least one second sensor to determine applied pressure to the input surface.

15. The input device of claim 14, wherein the processing system is configured to:
drive a sensing signal on a first subset of the first plurality of sensor electrodes, and receive a first resulting signal from the at least one second sensor electrode to determine positional information for the input objects; and
receive a second resulting signal from the at least one second sensor electrode to determine force information for the input objects;
wherein the first and second resulting signals correspond to the same driven signal.

16. An input device comprising:
a pliable component including a first plurality of sensor electrodes configured to detect input objects in a sensing region of the input device, the first plurality of sensor electrodes including a first subset of transmitter electrodes;
a second plurality of sensor electrodes configured to detect a force imparted to an input surface of the input device and configured for resistive coupling with the first subset of transmitter electrodes; and
a patterned force sensitive resistance (FSR) layer disposed between the pliable component and the second plurality of sensor electrodes;
wherein the resistive coupling between the transmitter electrodes and the second plurality of sensor electrodes varies in response to the applied force.

17. The input device of claim 16, wherein the FSR layer comprises at least one of a surface effect material and a bulk effect material, and wherein in response to force applied to the pliable component, the electrical resistance between the first plurality of sensor electrodes and the at least one second sensor electrode changes based on at least one of: i) increased surface area of the FSR layer coming into contact with one or both of the first plurality of sensor electrodes and the at least one second sensor electrode; and ii) a change in bulk resistance of the FSR layer.

18. The input device of claim 16, further comprising a support substrate configured to support the second plurality of sensor electrodes, and wherein the second plurality of sensor electrodes is further configured to measure a deflection of the pliable component towards the support substrate in response to input object pressure onto the input surface.

19. The input device of claim 16, further comprising a processing system communicatively coupled to and configured to operate the first and second pluralities of sensor electrodes, the processing system configured to:
perform trans-capacitive sensing using the first plurality of sensor electrodes to determine positional information for input objects in the sensing region; and
perform resistive sensing between a subset of the first plurality of sensor electrodes and the second plurality of sensor electrodes to determine applied pressure to the input surface based on a deflection of the first plurality of sensor electrodes relative to the second plurality of sensor electrodes.

20. An input device comprising:
a first plurality of sensor electrodes disposed in a pliable component and configured to detect input objects in a sensing region of the input device;
a second plurality of sensor electrodes disposed in a second layer and configured to detect a force imparted to an input surface of the input device;
a patterned force sensitive resistance (FSR) layer disposed between the pliable component and the second plurality of sensor electrodes and configured to change total resistivity in response to force applied to the input surface such that a resistive coupling between the first and second pluralities of sensor electrodes varies in response to the applied force; and
a processing system communicatively coupled to the first and second pluralities of sensor electrodes and configured to:
drive a sensing signal onto a first subset of the first plurality of sensor electrodes;
receive a first resulting signal, including effects of an input object in the sensing region, from a second subset of the first plurality of sensor electrodes;
receive a second resulting signal, including effects of a force imparted on the input surface, from the second plurality of sensor electrodes; and
determine positional and force information for input objects in the sensing region based on the first and second resulting signals.
